(19) United States
(12) Patent Application Publication
(10) Pub. No.: US 2009/0225491 A1
(43) Pub. Date: Sep. 10, 2009

(54) Metallized film capacitor

(76) Inventor: Hui-Chuan Yao, Changhua (TW)

Correspondence Address: CHARLES E. BAXLEY, ESQUIRE, 90 JOHN STREET, SUITE 309, NEW YORK, NY, 10038, US

(21) Appl. No.: 12/074,604

(22) Filed: Mar. 4, 2008

(51) Int. Cl. H01G 4/005

(52) U.S. Cl. 361/303

(57) ABSTRACT

A metallized film capacitor includes a capacitor unit having two insulating substrates superposed with each other each having an upper surface and a lower surface, four electrode layers applied onto the surfaces of the insulating substrates, and two of the electrode layers include an end terminal extended toward one end portion of the insulating substrates, and the other two electrode layers include an end terminal extended toward the other end portion of the insulating substrate for suitably increasing the capacitance of the capacitor unit without increasing the size or the volume of the metallized film capacitor and without complicating the structure of the metallized film capacitor.

### BACKGROUND OF THE INVENTION

1. Field of the Invention

The present invention relates to a metallized film capacitor, and more particularly to a metallized film capacitor including an increased capacitance without increasing the size or the volume of the metallized film capacitor and without complicating the metallized film capacitor.

2. Description of the Prior Art

Typical metallized film capacitors comprise a number of insulating foil film segments coated with metal electrode layers on each surface, and a number of insulation foil films disposed between the insulating foil film, and metal contact layers disposed in contact with the electrode segment groups of the foil film segments.

For example, U.S. Pat. No. 4,434,452 to Hamabe et al. discloses one of the typical metallized film capacitors comprising a number of insulating foil films and insulation foil films alternatively superposed with each other, and evaporated electrode layers applied onto the insulating foil films.

However, no evaporated electrode layers have been applied onto the insulation foil films such that the capacitance for the typical metallized film capacitor is limited or may not be increased, and the sizes or the volumes of the typical metallized film capacitors will be increased.

U.S. Pat. No. 5,608,600 to Lavene discloses another typical metallized film capacitor comprising two or more elongated dielectric webs each having electrodes metallized on an upper face thereof and each having one or more portions different in thickness from each other.

However, the electrodes are metallized on the upper face of each of the elongated dielectric webs, or metallized on both faces of one of two elongated dielectric webs such that the capacitance for the typical metallized film capacitor is also limited or may not be increased.

U.S. Pat. No. 5,905,628 to Okuno et al. discloses a further typical metallized film capacitor also comprising two or more plastic films each having evaporated electrodes metallized on an upper face thereof, the electrodes each include a high resistance area and a low resistance area having different in thickness from each other.

However, similarly, the electrodes are metallized on the upper face of each of the plastic films such that the capacitance for the typical metallized film capacitor is also limited or may not be increased.

U.S. Pat. No. 7,027,286 to Shiota et al. discloses a still further typical metallized film capacitor also comprising two or more dielectric films each having two or more or divisional and evaporated electrodes metallized on an upper face of each of the dielectric films and each having a slit formed between every two adjacent evaporated electrodes.

However, similarly, the electrodes are metallized on the upper face of each of the dielectric films such that the capacitance for the typical metallized film capacitor is also limited or may not be increased.

The present invention has arisen to mitigate and/or obviate the afore-described disadvantages of the conventional metallized film capacitors.

### SUMMARY OF THE INVENTION

The primary objective of the present invention is to provide a metallized film capacitor including an increased capacitance without increasing the size or the volume of the metallized film capacitor and without complicating the structure of the metallized film capacitor.

In accordance with one aspect of the invention, there is provided a metallized film capacitor comprising at least one capacitor unit including a first insulating substrate and a second insulating substrate, the first and the second insulating substrates each including a first surface and a second surface, a first electrode layer applied onto the first surface of the first insulating substrate and including an end terminal extended toward an end portion of the first insulating substrate, a second electrode layer applied onto the second surface of the second insulating substrate and including an end terminal extended toward an end portion of the second insulating substrate, a third electrode layer applied onto the second surface of the first insulating substrate and including an end terminal extended toward another end portion of the first insulating substrate, and a fourth electrode layer applied onto the first surface of the second insulating substrate and including an end terminal extended toward another end portion of the second insulating substrate for suitably increasing the capacitance of the capacitor unit without increasing the size or the volume of the metallized film capacitor and without complicating the structure of the metallized film capacitor.

The capacitor unit includes a first metallized contact and a second metallized contact, the end terminals of the first and the second electrode layers are extended toward the first metallized contact, and the end terminals of the third and the fourth electrode layers are extended toward the second metallized contact.

The first surface of the first and the second insulating substrates is an upper surface, and the second surface of the first and the second insulating substrates is a lower surface.

The first electrode layer, the second electrode layer, the third electrode layer, and the fourth electrode layer each may include one or more electrode segments divided or separated from each other.

A metallized film capacitor comprising at least one capacitor unit including a first insulating substrate and a second insulating substrate, the first and the second insulating substrates each including a first surface and a second surface, a first electrode layer applied onto the first surface of the first insulating substrate and including two end terminals extended toward end portions of the first insulating substrate, a second electrode layer applied onto the second surface of the second insulating substrate and including two end terminals extended toward end portions of the second insulating substrate, a third electrode layer applied onto the second surface of the first insulating substrate, and a fourth electrode layer applied onto the first surface of the second insulating substrate.

The capacitor unit includes a first metallized contact and a second metallized contact, the end terminals of the first and the second electrode layers are extended toward the first and the second metallized contacts.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial cross sectional view of a metallized film capacitor in accordance with the present invention;

FIG. 2 is another partial cross sectional view illustrating a portion of the metallized film capacitor;

FIG. 3 is a further partial cross sectional view illustrating the other arrangement of the metallized film capacitor;

FIG. 4 is a still further partial cross sectional view illustrating the further arrangement of the metallized film capacitor;

FIG. 5 is a still further partial cross sectional view illustrating the still further arrangement of the metallized film capacitor; and

FIG. 6 is a still further partial cross sectional view illustrating the still further arrangement of the metallized film capacitor.

### DETAILED DESCRIPTION OF THE PREFERRED EMBODIMENT

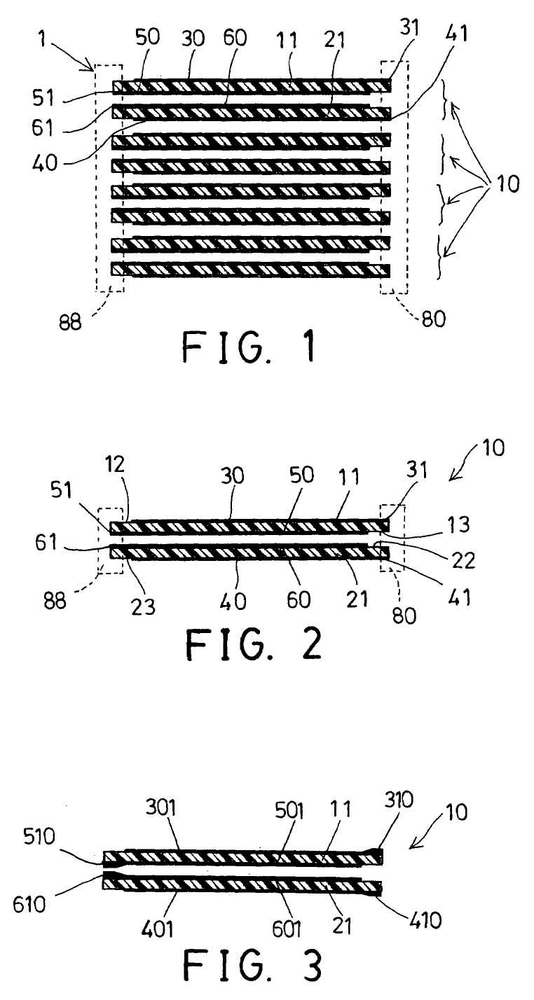

Referring to the drawings, and initially to FIGS. 1 and 2, a metallized film capacitor 1 in accordance with the present invention comprises one or more capacitor units 10 superposed with each other or one disposed above the other as shown in FIG. 1, and the capacitor units 10 each include two dielectric or insulating films or substrates 11, 21 made of polypropylene or polyethylene or other synthetic materials and superposed with each other, and each substrate 11, 21 having two surfaces 12, 13; 22, 23, such as a first or upper surface 12, 22 and a second or lower surface 13, 23, in which the ends of the insulating substrates 11, 21 are extended toward or engaged into two metallized contacts 80, 88 respectively as shown in dotted lines in FIGS. 1 and 2.

An evaporated electrode layer 30 is applied onto one of the surfaces 12, such as the upper surface 12 of one of the insulating films or substrates 11 and includes one end or terminal 31 extended toward and/or flush with one end portion of the insulating substrate 11 and extended toward one of the metallized contacts 80 and/or coupled to the first metallized contact 80, and a further or another evaporated electrode layer 40 is applied onto the other or the second or the lower surface 23 of the other insulating substrate 12 and includes one end or terminal 41 extended toward and/or flush with one end portion of the insulating substrate 12 and extended toward the first metallized contact 80 and/or coupled to the first metallized contact 80.

A still further evaporated electrode layer 50 is applied onto the other or the second or the lower surface 13 of the insulating substrate 11 and includes one end or terminal 51 extended toward and/or flush with the other end portion of the insulating substrate 11 and extended toward the other or the second metallized contact 88 and/or coupled to the second metallized contact 88, and a still further evaporated electrode layer 60 is applied onto the upper surface 22 of the insulating substrate 21 and includes one end or terminal 61 extended toward and/or flush with the other end portion of the insulating substrate 12 and extended toward the second metallized contact 88 and/or coupled to the second metallized contact 88, in which the end terminals 31, 41, 51, 61 of the evaporated electrode layers 30, 40, 50, 60 may include a uniform thickness equals to that of the respective evaporated electrode layers 30, 40, 50, 60 as shown in FIGS. 1 and 2.

The evaporated electrode layers 30, 40, 50, 60 may be made of zinc, aluminum, graphite, metals, alloys, or other conductive or semi-conductive materials, and the insulating substrates 11, 21 each include two evaporated electrode layers 30, 50; 40, 60 metallized or applied onto the two opposite surfaces 11, 12; 21, 22 thereof for allowing the capacitance of the capacitor units 10 to be suitably increased without increasing the size or the dimension or the volume of the metallized film capacitor 1 and without complicating the structure of the metallized film capacitor 1, and without spoiling the structure of the metallized film capacitor 1, or without decreasing the strength of the metallized film capacitor 1.

Alternatively, as shown in FIG. 3, the end terminals 310, 410, 510, 610 of the evaporated electrode layers 301, 401, 501, 601 may include a thickness greater than that of the evaporated electrode layers 301, 401, 501, 601 for increasing the attachment or the coupling of the end terminals 310, 410, 510, 610 of the evaporated electrode layers 301, 401, 501, 601 to the metallized contacts 80, 88 respectively.

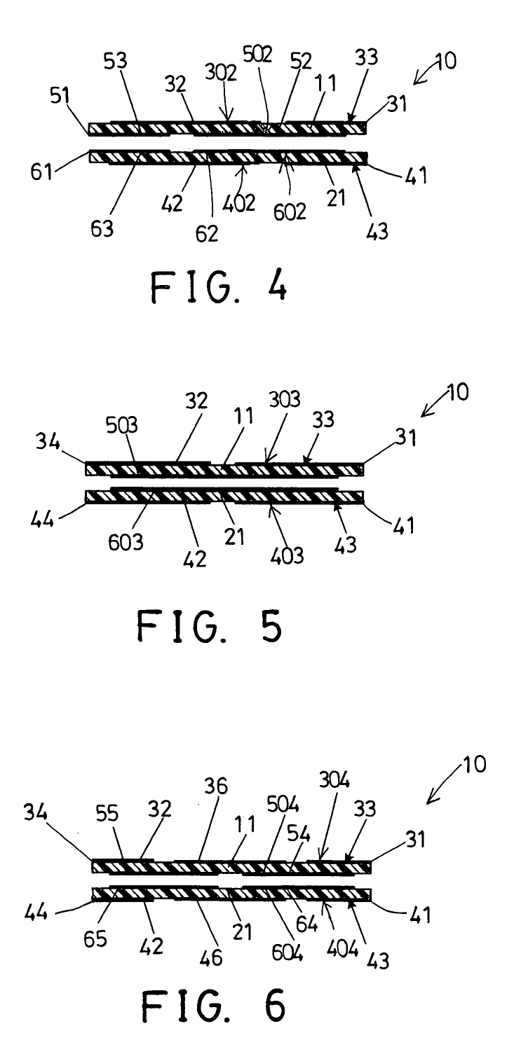

Further alternatively, as shown in FIG. 4, the evaporated electrode layers 302, 402, 502, 602 each may be separated or divided into two or more electrode segments 32, 33, 42, 43, 52, 53, 62, 63 or each may include two or more electrode segments 32, 33, 42, 43, 52, 53, 62, 63.

Further alternatively, as shown in FIG. 5, the evaporated electrode layers 303, 403 each may include two electrode segments 32, 33, 42, 43, and each may include two end terminals 31, 34; 41, 44 extended out of the insulating substrates 11, 12 and extended toward the metallized contacts 80, 88 and/or coupled to the metallized contacts 80, 88 respectively, and the evaporated electrode layers 503, 603 each may include a one-integral piece or structure having no end terminals extended out of the insulating substrates 11, 12.

Further alternatively, as shown in FIG. 6, the evaporated electrode layers 304, 404 each may include three or more electrode segments 32, 33, 36; 42, 43, 46 and each may include two end terminals 31, 34; 41, 44 extended out of the insulating substrates 11, 12 and extended toward the metallized contacts 80, 88 and/or coupled to the metallized contacts 80, 88 respectively.

Accordingly, the metallized film capacitor in accordance with the present invention includes an increased capacitance without increasing the size or the volume of the metallized film capacitor and without complicating the structure of the metallized film capacitor.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A metallized film capacitor comprising:
at least one capacitor unit including a first insulating substrate and a second insulating substrate, said first and said second insulating substrates each including a first surface and a second surface,
a first electrode layer applied onto said first surface of said first insulating substrate and including an end terminal extended toward an end portion of said first insulating substrate,
a second electrode layer applied onto said second surface of said second insulating substrate and including an end terminal extended toward an end portion of said second insulating substrate,
a third electrode layer applied onto said second surface of said first insulating substrate and including an end terminal extended toward another end portion of said first insulating substrate, and
a fourth electrode layer applied onto said first surface of said second insulating substrate and including an end terminal extended toward another end portion of said second insulating substrate.

2. The metallized film capacitor as claimed in claim 1, wherein said at least one capacitor unit includes a first metallized contact and a second metallized contact, said end terminals of said first and said second electrode layers are extended toward said first metallized contact, and said end terminals of said third and said fourth electrode layers are extended toward said second metallized contact.

3. The metallized film capacitor as claimed in claim 1, wherein said first surface of said first and said second insulating substrates is an upper surface, and said second surface of said first and said second insulating substrates is a lower surface.

4. The metallized film capacitor as claimed in claim 1, wherein said first electrode layer includes a first electrode segment and at least one second electrode segment.

5. The metallized film capacitor as claimed in claim 1, wherein said second electrode layer includes a first electrode segment and at least one second electrode segment.

6. The metallized film capacitor as claimed in claim 1, wherein said third electrode layer includes a first electrode segment and at least one second electrode segment.

7. The metallized film capacitor as claimed in claim 1, wherein said fourth electrode layer includes a first electrode segment and at least one second electrode segment.

8. A metallized film capacitor comprising:
at least one capacitor unit including a first insulating substrate and a second insulating substrate, said first and said second insulating substrates each including a first surface and a second surface,
a first electrode layer applied onto said first surface of said first insulating substrate and including two end terminals extended toward end portions of said first insulating substrate,
a second electrode layer applied onto said second surface of said second insulating substrate and including two end terminals extended toward end portions of said second insulating substrate,
a third electrode layer applied onto said second surface of said first insulating substrate, and
a fourth electrode layer applied onto said first surface of said second insulating substrate.

9. The metallized film capacitor as claimed in claim 8, wherein said at least one capacitor unit includes a first metallized contact and a second metallized contact, said end terminals of said first and said second electrode layers are extended toward said first and said second metallized contacts.

10. The metallized film capacitor as claimed in claim 8, wherein said first surface of said first and said second insulating substrates is an upper surface, and said second surface of said first and said second insulating substrates is a lower surface.

11. The metallized film capacitor as claimed in claim 8, wherein said first electrode layer includes a first electrode segment and at least one second electrode segment.

12. The metallized film capacitor as claimed in claim 8, wherein said second electrode layer includes a first electrode segment and at least one second electrode segment.

13. The metallized film capacitor as claimed in claim 8, wherein said third electrode layer includes a first electrode segment and at least one second electrode segment.

14. The metallized film capacitor as claimed in claim 8, wherein said fourth electrode layer includes a first electrode segment and at least one second electrode segment.
